(19) United States
(12) Patent Application Publication
(10) Pub. No.: US 2026/0188046 A1
(43) Pub. Date: Jul. 2, 2026

(54) FINGERPRINT CLASSIFICATION DEVICE AND METHOD USING FINGERPRINT CLASSIFICATION ALGORITHM BASED ON FINGERPRINT CLASSIFICATION SYSTEM FEATURES

(71) Applicant: REPUBLIC OF KOREA (NATIONAL FORENSIC SERVICE DIRECTOR MINISTRY OF THE INTERIOR AND SAFETY), Wonju-si (KR)

(72) Inventors: Young Il SEO, Wonju-si (KR); Kyu Young LIM, Wonju-si (KR)

(21) Appl. No.: 19/085,581

(22) Filed: Mar. 20, 2025

(30) Foreign Application Priority Data
Dec. 26, 2024 (KR) 10-2024-0196973

(51) Int. Cl. G06V 40/12

(52) U.S. Cl. CPC G06V 40/1376

(57) ABSTRACT

A fingerprint classification method using a fingerprint classification algorithm based on fingerprint classification system features includes obtaining a fingerprint image, performing first classification to third classification of the fingerprint image according to ridge pattern characteristics, and outputting a classification result.

### CROSS-REFERENCE TO RELATED APPLICATIONS

The present application is based on and claims priority to Korean Patent Application No. 10-2024-0196973, filed on Dec. 26, 2024, in the Korean Intellectual Property Office, which is incorporated herein by reference in its entirety.

### BACKGROUND

### 1. Field

One or more embodiments relate to a fingerprint classification device and method using a fingerprint classification algorithm based on fingerprint classification system features.

### 2. Description of the Related Art

Fingerprint evidence found at a crime scene is one of the important pieces of evidence that can be used to identify the criminal.

Once fingerprints are secured at the crime scene, work is done to identify who the fingerprints belong to. Currently, the National Police Agency uses the Automatic Fingerprint Identification System (AFIS) to obtain a list of key suspects. Once the list of key suspects is secured, experts determine whether the fingerprints are identical in the following order: analysis, comparison, evaluation, and verification.

When performing analysis, pattern types of the fingerprints are classified and quality levels of the fingerprints are evaluated. By classifying the pattern types of the fingerprints, fingerprints with different pattern types may be excluded and screened out.

If there are many fingerprints to compare, analysis requires a considerable amount of time and manpower. Therefore, an automated fingerprint classification system is needed because automating fingerprint classification may reduce time and manpower, and cross-verification may be performed to increase the reliability of fingerprint classification.

### SUMMARY

One or more embodiments include a fingerprint classification device and method using a fingerprint classification algorithm that easily performs classification when observing fingerprints at a crime scene based on characteristics of a fingerprint classification system.

According to one or more embodiments, a fingerprint classification method using a fingerprint classification algorithm based on fingerprint classification system features includes: obtaining a fingerprint image; performing first classification, which classifies the fingerprint image into a loop, whorl, arch, and other patterns according to ridge pattern characteristics; performing second classification, which classifies the loop into a right loop and left loop, classifies the whorl into a plain whorl, double-loop whorl, central pocket loop whorl, and accidental whorl, wherein the plain whorl is classified into a simple whorl and annular whorl, and the simple whorl and annular whorl are classified into clockwise rotation and counterclockwise rotation, and the double-loop whorl is classified into clockwise rotation and counterclockwise rotation, classifies the arch into a plain arch and tented arch, and classifies the other patterns into mutilated or extensively scarred patterns and amputations; performing third classification, which classifies the right loop and the left loop according to the number of ridges crossing an imaginary line between a core and delta, classifies the clockwise and counterclockwise rotations of the simple whorl, the annular whorl, and the double-loop whorl into inner tracing, outer tracing, and meeting tracing, and classifies the central pocket loop whorl and the accidental whorl into inner tracing, outer tracing, and meeting tracing; and outputting a classification result.

In an embodiment, the outputting of the classification result may include displaying results of the first classification to the third classification on a display, respectively.

In an embodiment, the outputting of the classification result may include highlighting nodes corresponding to the results of the first classification to the third classification on a logic tree using a graphical user interface (GUI).

According to one or more embodiments, a fingerprint classification device using a fingerprint classification algorithm based on fingerprint classification system features includes at least one memory storing at least one instruction and at least one processor, wherein the at least one processor is configured to execute the at least one instruction to: obtain a fingerprint image; perform first classification, which classifies the fingerprint image into a loop, whorl, arch, and other patterns according to ridge pattern characteristics; perform second classification, which classifies the loop into a right loop and left loop, classifies the whorl into a plain whorl, double-loop whorl, central pocket loop whorl, and accidental whorl, wherein the plain whorl is classified into a simple whorl and annular whorl, and the simple whorl and annular whorl are classified into clockwise rotation and counterclockwise rotation, and the double-loop whorl is classified into clockwise rotation and counterclockwise rotation, classifies the arch into a plain arch and tented arch, and classifies the other patterns into mutilated or extensively scarred patterns and amputations; perform third classification, which classifies the right loop and the left loop according to the number of ridges crossing an imaginary line between a core and delta, classifies the clockwise and counterclockwise rotations of the simple whorl, the annular whorl, and the double-loop whorl into inner tracing, outer tracing, and meeting tracing, and classifies the central pocket loop whorl and the accidental whorl into inner tracing, outer tracing, and meeting tracing; and output a classification result.

In an embodiment, the at least one processor is configured to execute the at least one instruction to output the classification result, including displaying results of the first classification to the third classification on a display, respectively.

In an embodiment, the at least one processor is configured to execute the at least one instruction to output the classification result, including highlighting nodes corresponding to the results of the first classification to the third classification on a logic tree using a GUI.

A non-transitory computer-readable recording medium having recorded thereon a computer program according to an embodiment may execute a fingerprint classification method using a fingerprint classification algorithm based on fingerprint classification system features using a computer.

Additional aspects will be set forth in part in the description which follows and, in part, will be apparent from the description, or may be learned by practice of the embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic configuration diagram of a fingerprint classification device according to an embodiment;

FIG. 2 is a view of a fingerprint classification system;

FIG. 3 is a flowchart illustrating a fingerprint classification method according to an embodiment;

FIG. 4 is a view of a core and a delta of a fingerprint;

FIG. 5 is a view of a loop;

FIG. 6 is a view of a right loop and a left loop;

FIG. 7 is a view of classification of a whorl;

FIG. 8 is a view of classification of an arch; and

FIGS. 9 and 10 are views illustrating an output of a display according to an embodiment.

### DETAILED DESCRIPTION

Hereinafter, embodiments will be described in detail with reference to the accompanying drawings. The same reference numerals are used to denote the same elements, and repeated descriptions thereof will be omitted.

It will be understood that although the terms “first,” “second,” etc. may be used herein to describe various components, these components should not be limited by these terms.

An expression used in the singular encompasses the expression of the plural, unless it has a clearly different meaning in the context.

It will be further understood that the terms “comprises” and/or “comprising” used herein specify the presence of stated features or components, but do not preclude the presence or addition of one or more other features or components.

In the specification, a “fingerprint” is a unique pattern on the tip of a person's finger, which is a ridge pattern on the surface of the skin. The “fingerprint” includes ridges, which are raised lines at the entrance of sweat glands in the skin of a fingertip, and valleys, which are indentations between the ridges.

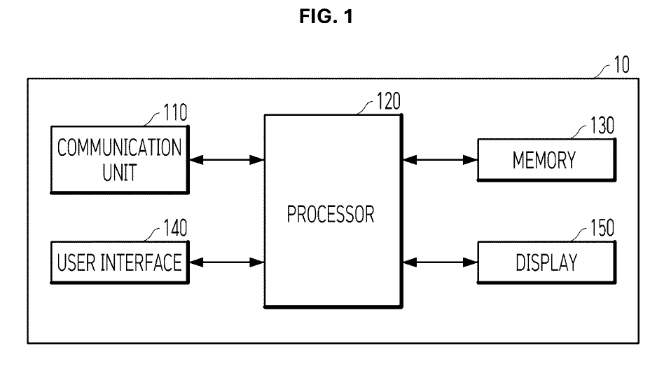

FIG. 1 is a schematic configuration diagram of a fingerprint classification device according to an embodiment.

Referring to FIG. 1, a fingerprint classification device 10 may include a communication unit 110, a processor 120, a memory 130, a user interface 140, and a display 150. The fingerprint classification device 10 to which the disclosure is applied may be an information processing device used by a user. However, the disclosure is not limited thereto, and the fingerprint classification device 10 may further include other components or some components may be omitted.

The fingerprint classification device 10 may include at least one of a personal computer (PC), a laptop computer, a mobile phone, a tablet PC, a smart phone, a personal digital assistant (PDA), and a portable multimedia player (PMP).

The communication unit 110 is connected to the processor 120 and the memory 130 to transmit and receive data. The communication unit 110 may be connected to another external device to transmit and receive data. Hereinafter, the expression “transmitting and receiving A” may indicate transmitting and receiving “information or data representing A.”

The communication unit 110 may be implemented as circuitry within the fingerprint classification device 10. For example, the communication unit 110 may include an internal bus and an external bus. As another example, the communication unit 110 may be an element that connects the fingerprint classification device 10 to an external device. The communication unit 110 may be an interface. The communication unit 110 may receive data from an external device and transmit the data to the processor 120 and the memory 130. For example, the communication unit 110 may receive a fingerprint image from a photographing device.

The processor 120 may control operations of the fingerprint classification device 10 according to an embodiment and perform logical operations.

The processor 120 processes data received by the communication unit 110 and data stored in the memory 130. The processor 120 may be a data processing device implemented in hardware having a circuit with a physical structure for performing desired operations. For example, desired operations may include code or instructions included in a program.

The processor 120 executes computer-readable code (e.g., software) stored in a memory (e.g., the memory 130) and instructions triggered by the processor 120.

The processor 120 controls the execution of a desired operation by executing at least one instruction stored in the memory 130. The at least one instruction may be stored in an internal memory included in the processor 120 or in the memory 130 included in a data processing device separately from the processor 120.

For example, the processor 120 may perform the following operations 210 to 250, which will be described in detail later.

The memory 130 stores data received by the communication unit 110 and data processed by the processor 120. The memory 130 may store a program (or application or software) that operates the fingerprint classification device 10. The stored program may be coded to control the fingerprint classification device 10 and may be executable by the processor 120.

The memory 130 may include a volatile memory such as static RAM (SRAM), dynamic RAM (DRAM) or synchronous DRAM (SDRAM), or a non-volatile memory such as a flash memory, phase-change RAM (PRAM), magnetic RAM (MRAM), resistive RAM (RRAM) or ferroelectric RAM (FRAM).

The user interface 140 may receive a user input for controlling the fingerprint classification device 10. The user interface 140 may include, but is not limited to, a touch panel for detecting a user's touch, a button for receiving a user's push operation, a mouse or keyboard for specifying or selecting a point on a user interface screen, etc.

The user interface 140 may be, for example, at least one graphical user interface (GUI) provided for controlling the fingerprint classification device 10.

The display 150 may display and output information processed in the fingerprint classification device 10. For example, the display 150 may display a GUI for controlling the fingerprint classification device 10.

The display 150 may be implemented as, but is not limited to, a liquid crystal display (LCD), a plasma display panel (PDP), an organic light emitting display (OLED), a field emission display (FED), an LED, a flexible display, a three-dimensional (3D) display, etc. Also, the display 150 may be configured as a touch screen and used as an input device in addition to an output device.

In addition, in other embodiments, the fingerprint classification device 10 may include more components than the components of FIG. 1. For example, the fingerprint classification device 10 may further include other components such as a battery and charging device that power internal components, and a database.

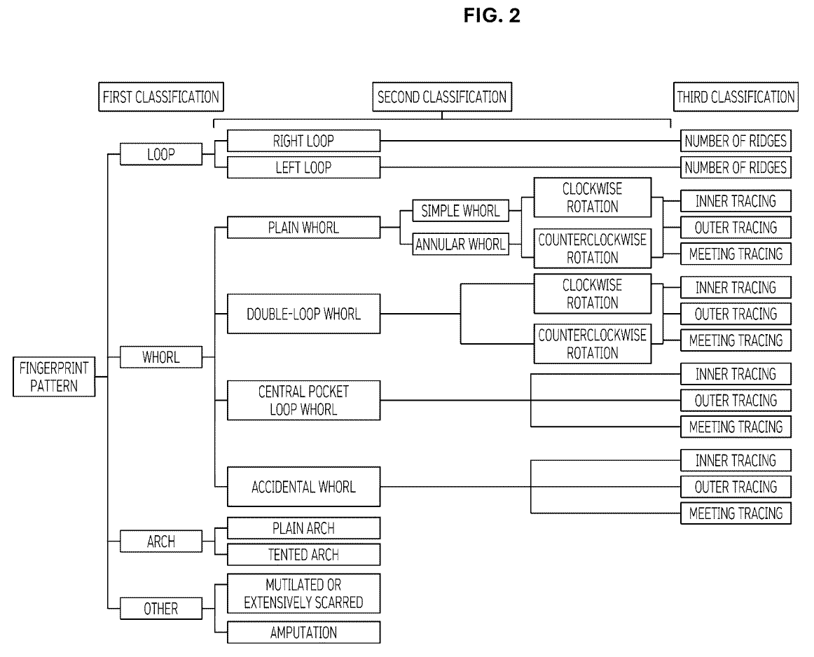

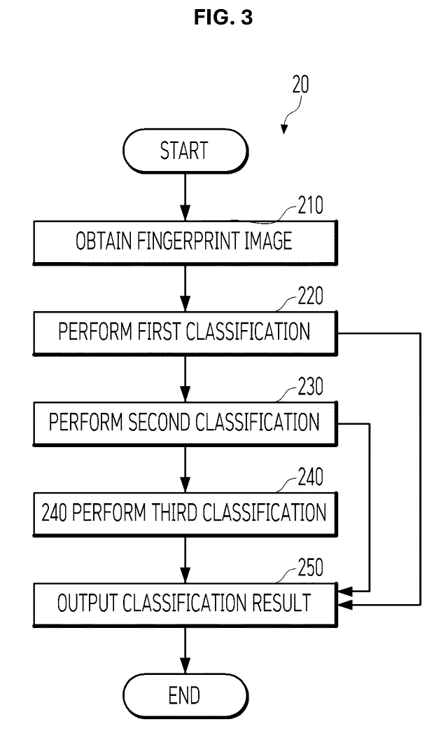

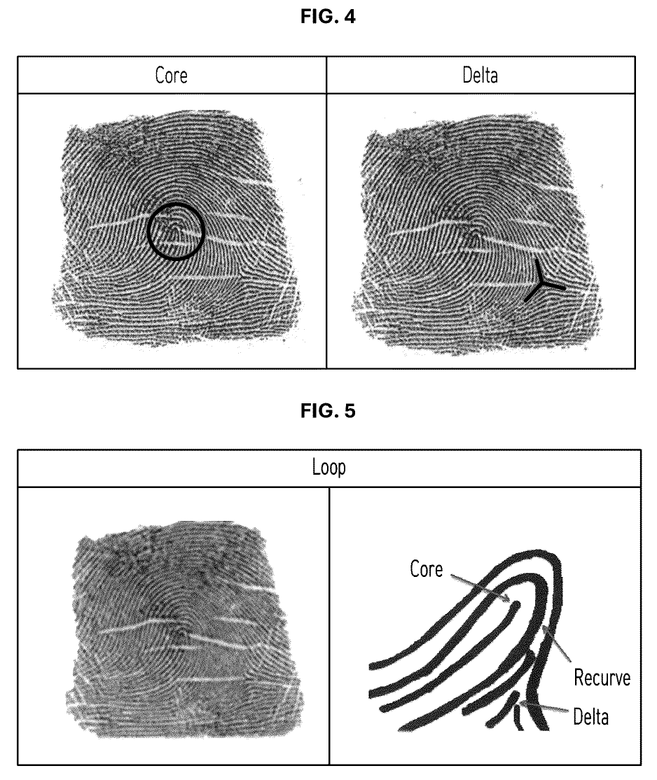

FIG. 2 is a view of a fingerprint classification system. FIG. 3 is a flowchart illustrating a fingerprint classification method according to an embodiment. FIG. 4 is a view of a core and a delta of a fingerprint. FIGS. 5 to 8 are views illustrating classified fingerprints.

Referring to FIGS. 2 to 8, a fingerprint classification method 20 according to an embodiment will be described.

The following operations 210 to 250 may be performed by the fingerprint classification device 10. In addition, referring to FIGS. 2 and 3, the following operations may be performed by applying a fingerprint classification algorithm using fingerprint classification system features.

In operation 210, the fingerprint classification device 10 may obtain a fingerprint image.

The fingerprint classification device 10 may receive a fingerprint image obtained from a photographing device through the communication unit 110. In addition, the fingerprint classification device 10 may include a camera including a lens and an image sensor. The image sensor may convert an image input by the lens into an electrical signal, and may be a semiconductor device such as a charge-coupled device (CCD) or a complementary metal oxide semiconductor (CMOS).

In operation 220, the fingerprint classification device 10 may perform first classification to classify the fingerprint image into a loop, whorl, arch, and other patterns according to ridge pattern characteristics.

Most pattern types of fingerprints are results of ridge flows and have one or more core and delta characteristics.

Referring to FIG. 4, a core becomes the center of a fingerprint pattern. A delta is an area where ridge paths flowing in three different directions form a triangle shape.

Referring to FIG. 5, a loop is a pattern in which ridges enter one side of a fingerprint, make a U-turn near the core, and emerge in the same direction. A delta is observed at the lower left of the core, and one or more loop ridges are observed between the delta and the core. The loop is the most commonly observed pattern, found in approximately 60% to 70% of the total population.

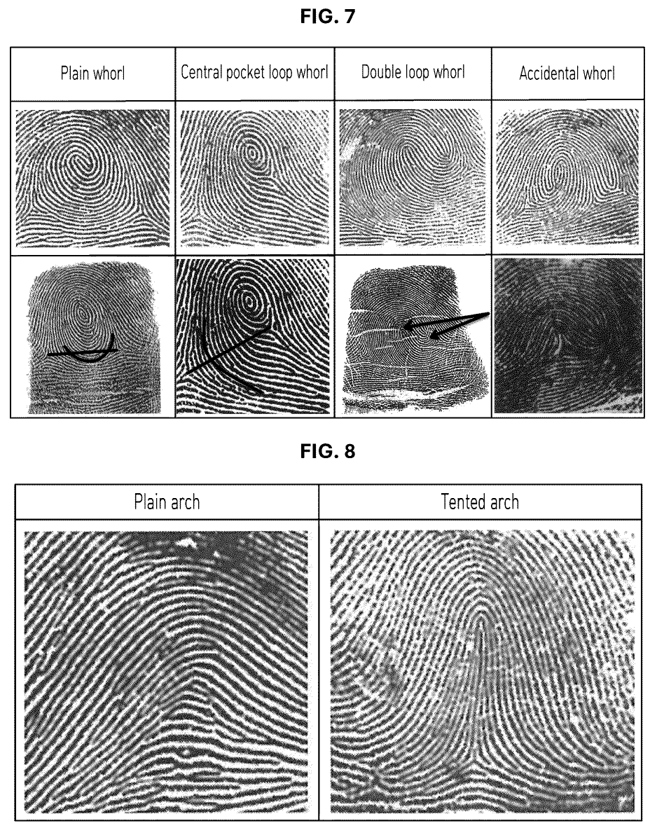

Referring to FIG. 7, a whorl is a pattern in which most ridges rotate around a core. The whorl has two deltas and a recurve (a loop ridge) in front of each delta. The whorl is the second most common fingerprint pattern type, found in approximately 30% to 35% of the total population.

Referring to FIG. 8, an arch is a pattern in which ridges enter one side of the fingerprint, rise from the center, and emerge on the other side. There is no delta in the arch, and the core of most arches is unclear.

Other patterns are those that do not fall into the above categories of the loop, whorl, and arch.

In operation 230, the fingerprint classification device 10 may perform the following second classification.

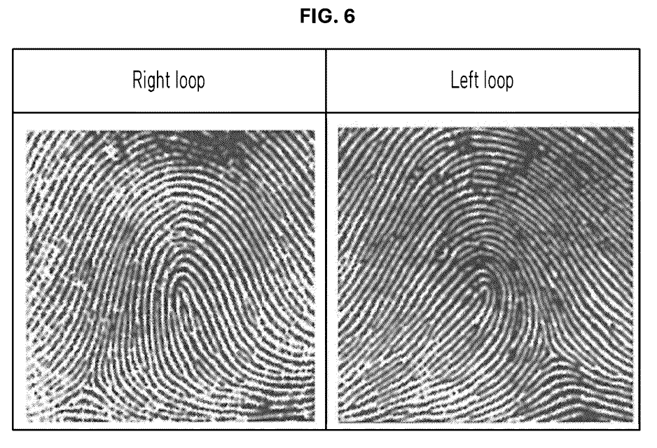

Referring to FIG. 6, the loop may be classified into a right loop and left loop depending on the shape of a ridge.

The right loop is a pattern in which ridges enter the right side of a fingerprint, make a U-turn near the core, and emerge in the same direction. The left loop is a pattern in which ridges enter the left side of the fingerprint, make a U-turn near the core, and emerge in the same direction.

Conventionally, the loop was classified into a radial loop and ulnar loop. The radial loop is a loop that is tilted toward the radius and the inner bone of the forearm, and the ulnar loop is a loop that flows toward the ulna and the little finger. Because it is impossible to determine whether the loop is a radial loop or an ulnar loop from fingerprints found at a crime scene, the loop is classified into a right loop and a left loop that can be distinguished when observing the fingerprints at the crime scene.

Referring to FIG. 7, the whorl may be classified into a plain whorl, double-loop whorl, central pocket loop whorl, and accidental whorl.

The plain whorl resembles elongated concentric ellipses, and an imaginary straight line from one delta to another delta passes through at least two points of one recurve. The plain whorl is the most common type of whorl. For example, the plain whorl resembles a target, and its core is sometimes defined as the bull's-eye of the target.

The plain whorl may be classified into a simple whorl and annular whorl. The simple whorl is a spiral shape with a core that rotates clockwise (or counterclockwise), and the annular whorl is a pattern with a core composed of concentric ellipses.

The simple whorl and annular whorl may be classified into clockwise rotation if the core is a vortex shape that rotates clockwise, and into counterclockwise rotation if the core is a vortex shape that rotates counterclockwise.

The double-loop whorl contains two loops that are curved around each other and has two deltas.

The double-loop whorl may be classified into clockwise rotation if the core is a vortex shape that rotates clockwise, and into counterclockwise rotation if the core is a vortex shape that rotates counterclockwise.

In this way, by performing subclassifications for a plain whorl and double-loop whorl, the classification of whorls can be further refined, strengthening a system for screening out other pattern types of fingerprints.

The central pocket loop whorl has a small loop or circular vortex trapped within the loop. The central pocket loop whorl has two deltas, and an imaginary straight line from one delta to the other delta passes through the ridge once (failed to cut the recurve).

The accidental whorl is a pattern that does not fall into the three types of the plain whorl, double-loop whorl, and central pocket loop whorl described above.

Referring to FIG. 8, the arch may be classified into a plain arch and tented arch.

The plain arch is a smooth arch pattern in which all ridges are raised and lowered relatively evenly throughout the pattern. The plain arch is a pattern without any looped ridges or ridges that form angles with the recurve or a wave pattern.

The tented arch is an arch pattern with one or more ridges that form an angle with an arch flow. The tented arch often forms right angles with ridges at the base of the fingerprint.

Other patterns may be classified into mutilated or extensively scarred patterns and amputations.

In operation 240, the fingerprint classification device 10 may perform the following third classification.

The right loop and left loop may be classified by the number of ridges crossing an imaginary line between the core and the delta.

Clockwise and counterclockwise rotations of the simple whorl, annular whorl, and double-loop whorl may be classified into inner tracing, outer tracing, and meeting tracing.

In a case of the clockwise and counterclockwise rotations of the simple whorl, when following a ridge path from a left delta to a right delta, if there are three or more ridges inside the right delta, it may be classified into the inner tracing, if there are three or more ridges outside the right delta, it may be classified into the outer tracing, and if there are one or two ridges inside or outside the right delta or tracing stops at the right delta, it may be classified into the meeting tracing.

In a case of the clockwise and counterclockwise rotations of the annular whorl, when following a ridge path from a left delta to a right delta, if there are three or more ridges inside the right delta, it may be classified into the inner tracing, if there are three or more ridges outside the right delta, it may be classified into the outer tracing, and if there are one or two ridges inside or outside the right delta or tracing stops at the right delta, it may be classified into the meeting tracing.

In a case of the clockwise and counterclockwise rotations of the double-loop whorl, when following a ridge path from a left delta to a right delta, if there are three or more ridges inside the right delta, it may be classified into the inner tracing, if there are three or more ridges outside the right delta, it may be classified into the outer tracing, and if there are one or two ridges inside or outside the right delta or tracing stops at the right delta, it may be classified into the meeting tracing.

In addition, the central pocket loop whorl and the accidental whorl may be classified into inner tracing, outer tracing, and meeting tracing.

In a case of the central pocket loop whorl, when following a ridge path from a left delta to a right delta, if there are three or more ridges inside the right delta, it may be classified into the inner tracing, if there are three or more ridges outside the right delta, it may be classified into the outer tracing, and if there are one or two ridges inside or outside the right delta or tracing stops at the right delta, it may be classified into the meeting tracing.

In a case of the accidental whorl, when following a ridge path from a left delta to a right delta, if there are three or more ridges inside the right delta, it may be classified into the inner tracing, if there are three or more ridges outside the right delta, it may be classified into the outer tracing, and if there are one or two ridges inside or outside the right delta or tracing stops at the right delta, it may be classified into the meeting tracing.

In operation 250, the fingerprint classification device 10 may output a classification result.

Operation 250 of outputting the classification result may include displaying results of the first classification to the third classification, respectively.

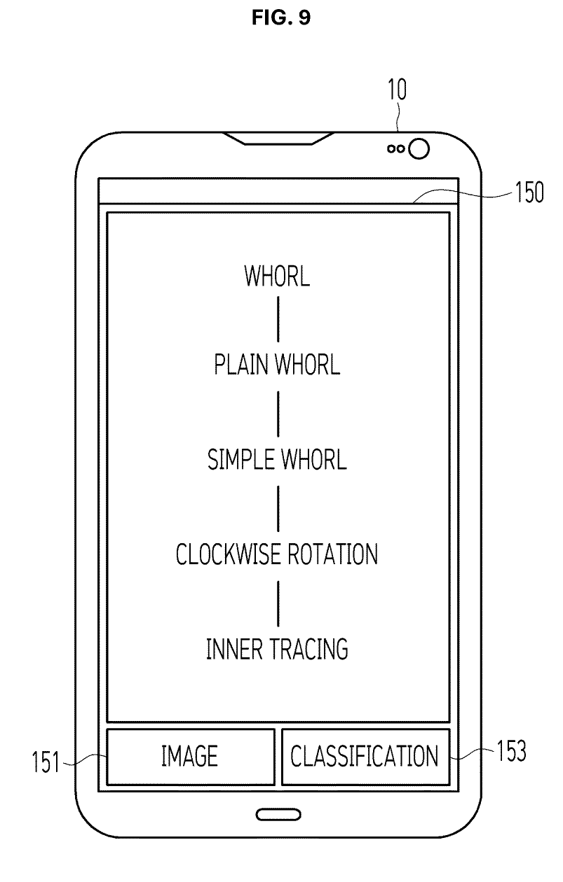

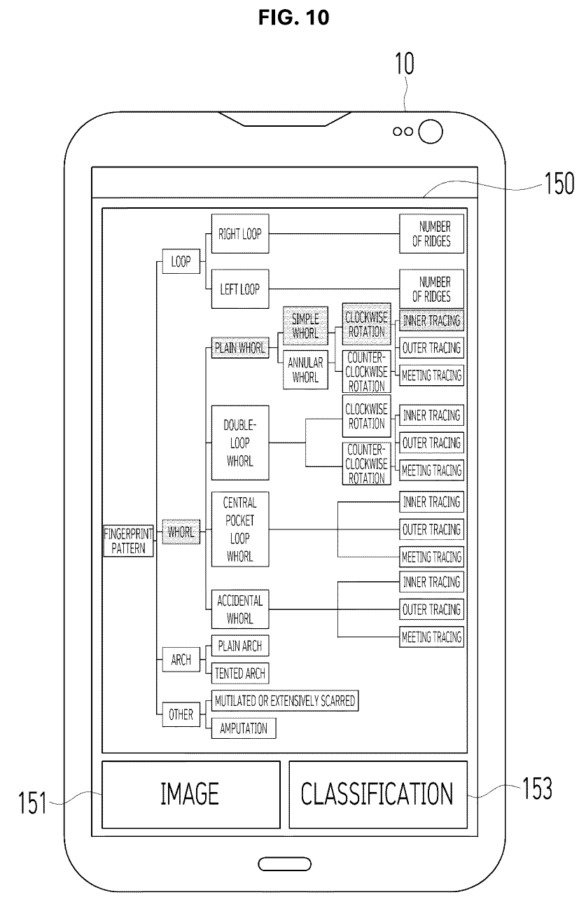

FIGS. 9 and 10 are views illustrating an output of a display according to an embodiment.

For example, referring to FIG. 9, a classification result for a specific fingerprint image may be displayed on the display 150 as follows. The results of the first classification to the third classification may be displayed in order as ‘whorl-plain whorl-simple whorl-clockwise rotation-inner tracing’.

As another example, referring to FIG. 10, operation 250 may include highlighting nodes corresponding to the results of the first classification to the third classification on a logic tree using a GUI.

Highlighting a node corresponding to a specific classification result while displaying a logic tree may be expressed by changing the color of the node or changing the configuration of the node (node shape, font size, etc.). In addition, highlighting can be done by expanding or reducing the size of the node.

For example, when a user selects a fingerprint image by an ‘image’ button 151 and classifies it by a ‘classification’ button 153, the fingerprint classification device 10 may output the results of the first classification to the third classification by highlighting the corresponding nodes as described above. Accordingly, it is possible to check where each classification result is located on the logic tree.

The fingerprint classification method 20 according to various embodiments illustrated in FIG. 3 can be written as computer programs and can be implemented in general-use digital computers that execute the programs using a non-transitory computer-readable recording medium. The non-transitory computer-readable recording medium may be a magnetic storage medium (e.g., ROM, a floppy disk, a hard disk, etc.), or an optical reading medium (e.g., a CD ROM, a digital versatile disk (DVD) or the like).

According to an embodiment, fingerprint classification may be easily performed when observing fingerprints at a crime scene, thereby contributing to reducing fatigue of experts, increasing analysis speed, and improving accuracy when analyzing a crime scene.

The description herein is for describing the disclosure and numerous modifications and adaptations will be readily apparent to one of ordinary skill in the art without departing from the spirit and scope of the disclosure. For example, the relevant results may be achieved even when the described technologies are performed in a different order than the described methods, and/or even when the described elements such as systems, structures, devices, and circuits are coupled or combined in a different form than the described methods or are replaced or substituted by other elements or equivalents.

Accordingly, while the disclosure has been particularly shown and described with reference to embodiments thereof, it will be understood that various changes in form and details may be made therein without departing from the spirit and scope of the following claims.

What is claimed is:

1. A fingerprint classification method using a fingerprint classification algorithm based on fingerprint classification system, the fingerprint classification method comprising:
obtaining a fingerprint image;
performing first classification, which classifies the fingerprint image into a loop, whorl, arch, and other patterns according to ridge pattern characteristics;
performing second classification, which classifies the loop into a right loop and left loop,
classifies the whorl into a plain whorl, double-loop whorl, central pocket loop whorl, and accidental whorl,
wherein the plain whorl is classified into a simple whorl and annular whorl, and the simple whorl and annular whorl are classified into clockwise rotation and counterclockwise rotation, and
the double-loop whorl is classified into clockwise rotation and counterclockwise rotation,
classifies the arch into a plain arch and tented arch, and
classifies the other patterns into mutilated or extensively scarred patterns and amputations;
performing third classification, which classifies the right loop and the left loop according to the number of ridges crossing an imaginary line between a core and delta,
classifies the clockwise and counterclockwise rotations of the simple whorl, the annular whorl, and the double-loop whorl into inner tracing, outer tracing, and meeting tracing, and
classifies the central pocket loop whorl and the accidental whorl into inner tracing, outer tracing, and meeting tracing; and
outputting a classification result.

2. The fingerprint classification method of claim 1, wherein the outputting of the classification result comprises:
displaying results of the first classification to the third classification on a display, respectively.

3. The fingerprint classification method of claim 1, wherein the outputting of the classification result comprises:
highlighting nodes corresponding to the results of the first classification to the third classification on a logic tree using a graphical user interface (GUI).

4. A fingerprint classification device using a fingerprint classification algorithm based on fingerprint classification system features, the fingerprint classification device comprising:
at least one memory storing at least one instruction; and
at least one processor,
wherein the at least one processor is configured to execute the at least one instruction to:
obtain a fingerprint image;
perform first classification, which classifies the fingerprint image into a loop, whorl, arch, and other patterns according to ridge pattern characteristics;
perform second classification, which classifies the loop into a right loop and left loop,
classifies the whorl into a plain whorl, double-loop whorl, central pocket loop whorl, and accidental whorl,
wherein the plain whorl is classified into a simple whorl and annular whorl, and the simple whorl and annular whorl are classified into clockwise rotation and counterclockwise rotation, and
the double-loop whorl is classified into clockwise rotation and counterclockwise rotation,
classifies the arch into a plain arch and tented arch, and
classifies the other patterns into mutilated or extensively scarred patterns and amputations;
perform third classification, which classifies the right loop and the left loop according to the number of ridges crossing an imaginary line between a core and delta,
classifies the clockwise and counterclockwise rotations of the simple whorl, the annular whorl, and the double-loop whorl into inner tracing, outer tracing, and meeting tracing, and
classifies the central pocket loop whorl and the accidental whorl into inner tracing, outer tracing, and meeting tracing; and
output a classification result.

5. The fingerprint classification device of claim 4, wherein the at least one processor is configured to execute the at least one instruction to:
output the classification result, including displaying results of the first classification to the third classification on a display, respectively.

6. The fingerprint classification device of claim 4, wherein the at least one processor is configured to execute the at least one instruction to:
output the classification result, including highlighting nodes corresponding to the results of the first classification to the third classification on a logic tree using a graphical user interface (GUI).

7. A computer program stored on a non-transitory computer-readable storage medium for executing the method of claim 1 using a computer.
